(19) United States
(12) Patent Application Publication
(10) Pub. No.: US 2022/0189345 A1
(43) Pub. Date: Jun. 16, 2022

(54) SHELF TAG IDENTIFICATION SYSTEM

(71) Applicant: GRANDVILLE PRINTING CO, Grandville, MI (US)

(72) Inventors: Dennis M. Kucharczyk, Grandville, MI (US); Anthony S. Trevino, Grandville, MI (US)

(73) Assignee: GRANDVILLE PRINTING CO, Grandville, MI (US)

(21) Appl. No.: 17/686,515

(22) Filed: Mar. 4, 2022

Related U.S. Application Data
(63) Continuation-in-part of application No. 17/376,290, filed on Jul. 15, 2021.
Application No. 17/376,290 is a continuation-in-part of application No. 16/930,404, filed on Jul. 16, 2020.
(60) Provisional application No. 63/072,958, filed on Sep. 1, 2020.
(60) Provisional application No. 62/874,690, filed on Jul. 16, 2019.

(51) Int. Cl. G09F 3/02; B42F 3/00; G09F 3/10; B65D 5/52

(52) U.S. Cl. CPC G09F 3/02; B42F 3/003; B42F 13/16; B65D 5/5206; G09F 3/10

(57) ABSTRACT

A shelf tag/sign distribution system that includes identifications of areas of stores, dates, end caps and other information to provide for the accurate and simplified installation of tags/signs within a store. The sheets can be arranged within a package that includes coded information as to the types of tags that are contained within the package. The shelf tags can be hung in a downward or upward extending orientation.

### CROSS REFERENCE TO RELATED APPLICATIONS AND CLAIM OF PRIORITY

The present application is a continuation-in-part of and claims priority under 35 U.S.C. § 120 to commonly assigned, U.S. application Ser. No. 17/376,290, filed Jul. 15, 2021, entitled SHELF TAG IDENTIFICATION SYSTEM, which claims priority to U.S. application Ser. No. 16/930,404, filed Jul. 16, 2020, entitled BINDER BOX, which claims the priority benefits under the provisions of 35 U.S.C. § 119, basing said claim of priority on related U.S. Provisional Application No. 62/874,690 filed Jul. 16, 2019, all of which are incorporated herein by reference and claim priority benefits under the provisions of 35 U.S.C. § 119 to U.S. Provisional Application No. 63/072,958, filed on Sep. 1, 2020, all of which are incorporated herein by reference.

### BACKGROUND OF THE INVENTION

The present invention relates to a method of printing, distributing, and placing price information, such as price tags and point-of-purchase signs for use in retail store shelves and displays. For example, it includes aspects relating to price information tags attached to shelves under the products being sold and to other information associated with products for sale. The present method is particularly useful with just-in-time printing and delivery of tags with minimal lead times, and for faster tag changes at stores while reducing labor cost. However, the present invention is contemplated to be broader in scope than just printing and distributing of price information tags.

Consumers (as well as consumer protection laws) require accurate information about products being displayed on store shelves. Price information (such as a price change) placed on a shelf “too soon” or “too late” causes considerable consumer dissatisfaction (e.g., out-of-stocks or “mis-stocks”) and/or causes significant in-store confusion or delays (e.g., price checks), as well as concern from regulatory agencies. However, getting tags onto shelves is a surprisingly complex and difficult task for a number of reasons. For example, buyers may be negotiating on supplier prices right up to the last possible minute, such that prices and even product availability may be uncertain until the “last possible minute.” Product availability and delivery concerns may also cause uncertainty right up to the last possible minute. Management often wants to make product pricing decisions as close as possible to the “on sale” date so that uncertainties about future product availability and consumer purchasing trends and other price-related strategies can be incorporated into the pricing decisions. Thus, a system is desired allowing retail prices to be set as late as possible to allow optimal (last minute) control over retail pricing . . . and further a system is desired giving greater control to the retail store management late in the printing process.

Aside from timing issues noted above, information management is very difficult. Large stores now carry hundreds of thousands of products, and the logistics of getting timely-printed price information tags in appropriate places on store shelves is a time-consuming, highly-manually-intensive task. An amazing amount of time is spent inefficiently walking from one shelf to another, and from one end of a shelf to another end, as price information tags are attached to shelves under associated product. Further, this often leads to errors, such as tags being put under the wrong product, tags simply not being put up at all, and/or tags being put up at the wrong time. Further, attachment of the tags must be secure and long lasting, yet inexpensive and easily engaged. Thus, improving the efficiency and accuracy of the placement of tags on shelves would be advantageous.

### SUMMARY OF THE INVENTION

One aspect of the present invention is a compilation of sheets of shelf tags. The compilation of sheets of shelf tags are contained within a package. A label can be placed on the package to indicate what groupings of shelf tags are contained within the package. The compilation of arranged sheets of shelf tags includes a number of sheets of shelf tags with sections of color printed on a portion of an edge surface. The color indicates in what area of the store the shelf tags will be placed. Sheets with sections of color are positioned within the package to have similar colors in at least one group. Each different color on a portion of the edge surface of the sheets of shelf tags is staggered such that a grouping of one color has an edge coloring that is offset from an adjacent grouping of a different color within the package.

Another aspect of the present invention is a compilation of sheets of shelf tags. Sections of color are printed on a portion of an edge surface of a number of the sheets of shelf tags indicating what area in the store the shelf tags are to be placed. A plurality of sheets are positioned to have similar colors in at least one group. Each different color on the portion of the edge surface of the sheets of shelf tags is staggered such that a grouping of one color will have a colored edge that is offset from an adjacent grouping of a different color. A second section of color is printed on a portion of an edge surface of the plurality of sheets for indicating the date on which the self tag is to be placed within the store.

Yet another aspect of the present invention is a package containing a number of sheets of shelf tags. The sheets of shelf tags include a first section of color printed on a portion of an edge surface of a number of the sheets of shelf tags for indicating in what area of the store the shelf tags are to be placed. The package includes a label on the package indicating what groupings of shelf tags are contained within the package. The shelf tags also include a second section of colors printed on a portion of an edge surface of the plurality of a number of the sheets of shelf tags that indicate the date on which the shelf tags are to be placed within the store. The sheets of shelf tags are positioned in the package in groupings based upon date and/or similar colors associated with areas of the store.

These and other advantages of the invention will be further understood and appreciated by those skilled in the art by reference to the following written specification, claims, and appended drawings.

### BRIEF DESCRIPTION OF THE DRAWINGS

FIG. 1 is perspective view of a binder box assembly embodying one aspect of the present invention;

FIG. 2 is top view of the binder box shown in FIG. 1, with the top surface rotated and two sheets;

FIG. 3 is a top view of a sheet showing instruction for assembly and use of the binder box assembly;

FIG. 4 is a side perspective view of the binder box shown in FIG. 1, in a closed position;

FIG. 5 is a front perspective view of a binder box assembly with edge identification on the sheets of shelf tags;

FIG. 6 is a top and side view of a pair of binders;

FIG. 7 is top perspective view of the attachment of a binder to a portion of the binder box shown in FIG. 1;

FIG. 8 is a side perspective view of one end of the binder before insertion into the binder box as shown in FIG. 7;

FIG. 9 is a partial top perspective view of a sheet aligned with the binder openings in a binder box;

FIG. 10 is a partial top perspective view of the binder being inserted through the binder opening in a sheet;

FIG. 11 is a top view of a sheet showing the dimensions of various aspects of the sheet;

FIG. 12 is a top view of a sheet with perforations permitting the bottom portion of each shelf tag to be separated from the sheet when the sheet is bent at the perforations;

FIG. 13 is a top view of a sheet with adhesive being used on only a portion of the shelf tags;

FIG. 14 is top perspective view of the binder box of FIG. 1 unassembled;

FIG. 15 is a front perspective view of a binder box assembly utilizing magnets to stand the binder box assembly in a raised position;

FIG. 16 is a top perspective view of the binder box of FIG. 1 with the top surface removed;

FIG. 17 is a side perspective view of the binder box shown in FIG. 1 with the top surface in a partially closed position;

FIG. 18 is a side perspective view of the binder box of FIG. 17 in an open position;

FIG. 19 is a top view, side perspective view, and a side view of a binder;

FIG. 20 is a side perspective view of the binder box assembly of FIG. 1 without any sheets;

FIG. 21 is a top view of a tile sheet with different department breakdowns that are associated with various colors;

FIG. 22 is a top view of a sheet with break day information;

FIG. 23 is a top view of a sheet listing the departments that have been associated with abbreviations and colors for the store;

FIG. 24 is a top view of a page label and a file label;

FIG. 25 is a partial front perspective view of a binder box assembly with edge identification on the sheets of shelf tags including end cap identifications;

FIG. 26 is a front perspective view of edge identification on the top edge of category signs;

FIG. 27 is a front view of a category sign with a break day color and an edge identification for store location;

FIG. 28 is a front perspective view of edge identification on a sign;

FIG. 29 is a top view of a sheet of tags with some tags with adhesive positioned to have the tag be on a shelf in an upward position and tome tags on a shelf in a downward hanging position;

FIG. 30 is a perspective view of shelf tags hanging downward next to shelf tags in an upward position; and

FIG. 31 is a top view of a sheet of unit price labels.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

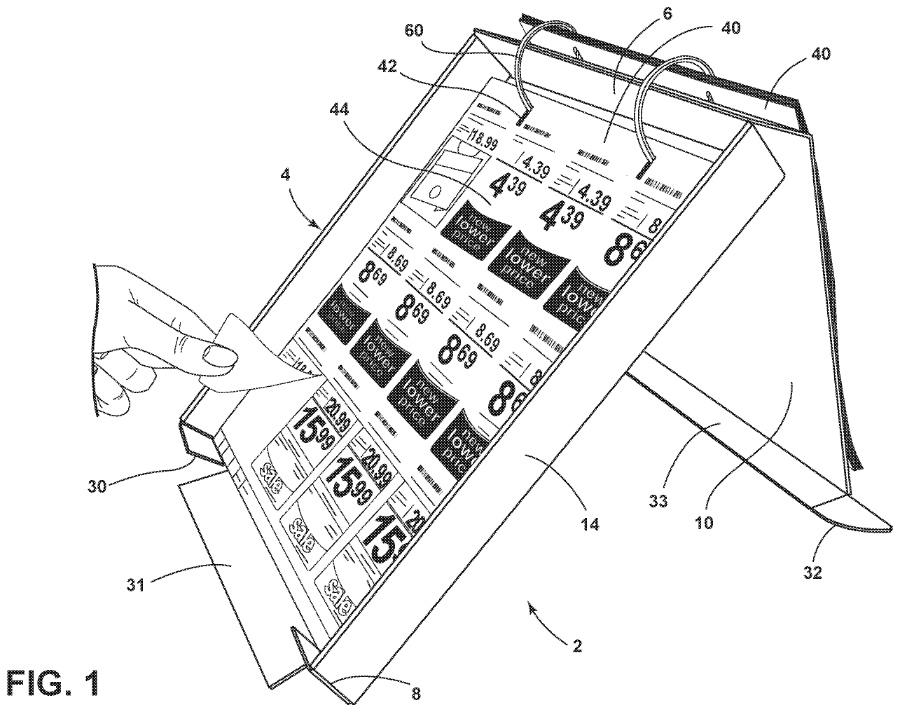

An exemplary embodiment of the binder box assembly 2 embodying an aspect of the present invention is shown in FIG. 1. The binder box assembly 2 includes a binder box 4, a number of sheets 40 with shelf tags 44, and one or more binders 60 which couple the sheets 40 to the binder box 4.

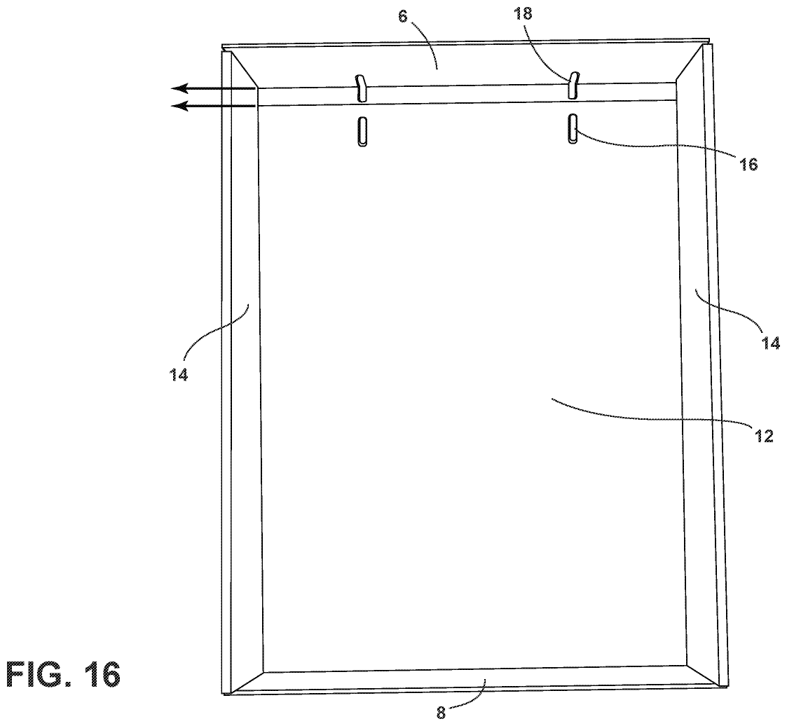

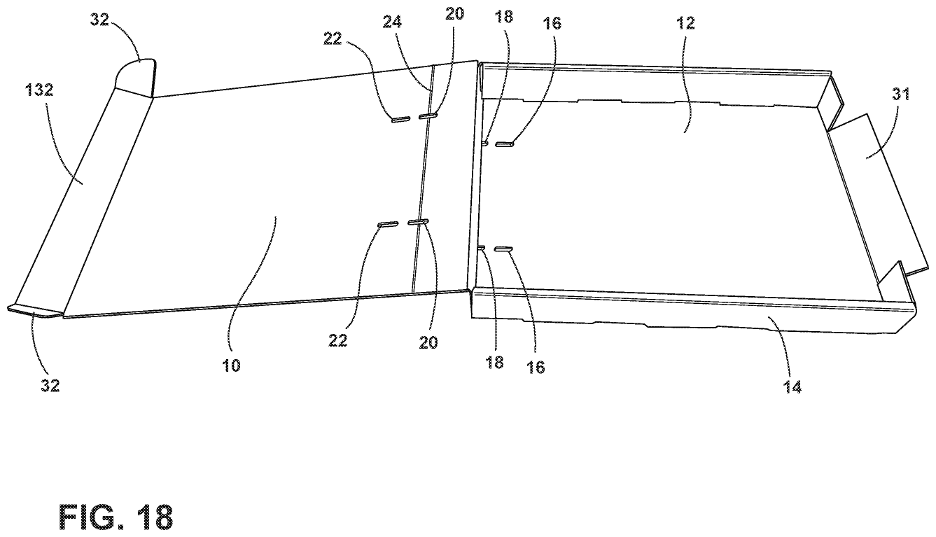

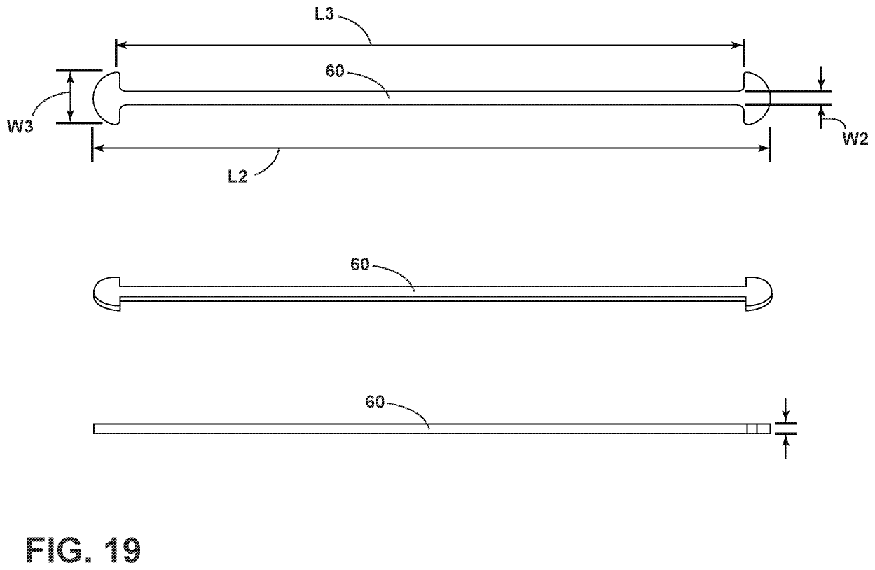

As illustrated in FIGS. 1, 2, 14-18, and 20, the binder box 4 has a back wall 6, a front wall 8, a top surface 10, a bottom surface 12, and two sidewalls 14. The binder box 4 has a number of aligned binder openings to receive binders 60. In the illustrated embodiment, the binder box assembly 2 utilizes two binders 60, thus, there are two sets of aligned openings for the binders 60. The binder box 4 has first binder openings 16 located on the bottom surface 12 as best illustrated in FIGS. 14 and 18. Second binder openings 18 are located at the transition 26 between the bottom surface 12 and the back wall 6 such that a part of the second binder opening 18 is located in the bottom surface 12 and a part of the second binder opening 18 is located in the back wall 6. In the illustrated embodiments, approximately half of the second binder opening 18 is located on the bottom surface 12 and half in the back wall 6. However, the second binder opening 18 can positioned such that the bottom surface 12 has more or less than half of the second binder opening 18.

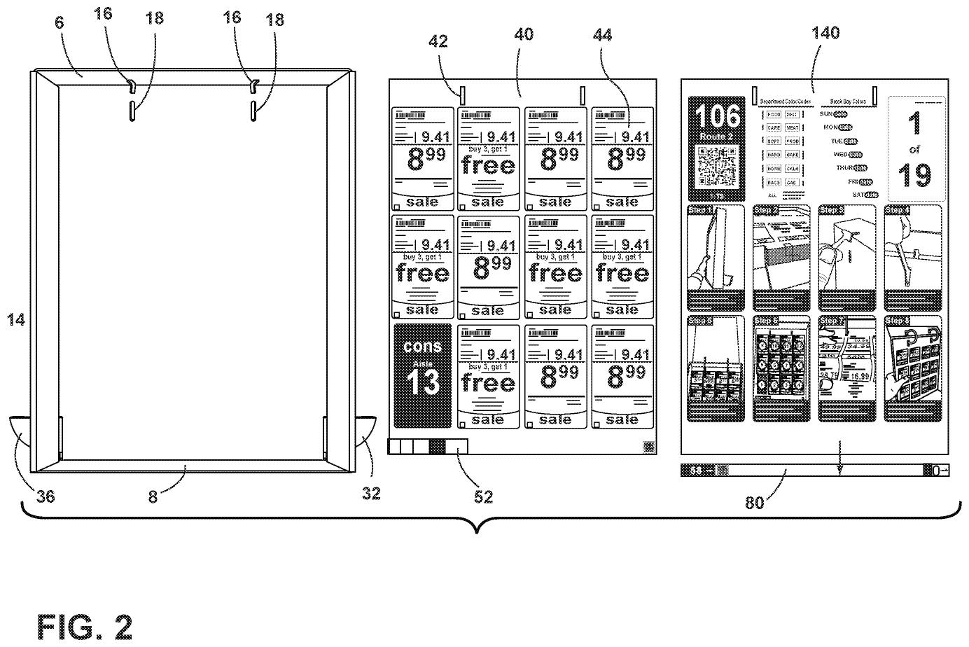

The top surface 10 has fourth binder openings 20 and fifth binder openings 22. When the top surface 10 is rotated over the back wall 6 and bottom surface 12, as shown in FIG. 2, the fourth binder openings 20 of the top surface 10 will generally overlap with the second binder openings 18 and the fifth binder openings 22 will overlap with the first binder openings 16. In this arrangement, the binder 60 can be inserted through the sets of aligned and overlapping binder openings in the binder box 4 and the sheets 40 as to permit the binder box 4 to be easily carried.

The top surface 10 can alternatively be entirely removed by tearing the top surface 10 at the perforated transition 29 between the back wall 6 and the top surface 10. In such an arrangement, the binder 60 can be inserted into the first binder opening 16 and the second binder opening 18 and coupled to the sheets 40 to the binder box 4 as described below.

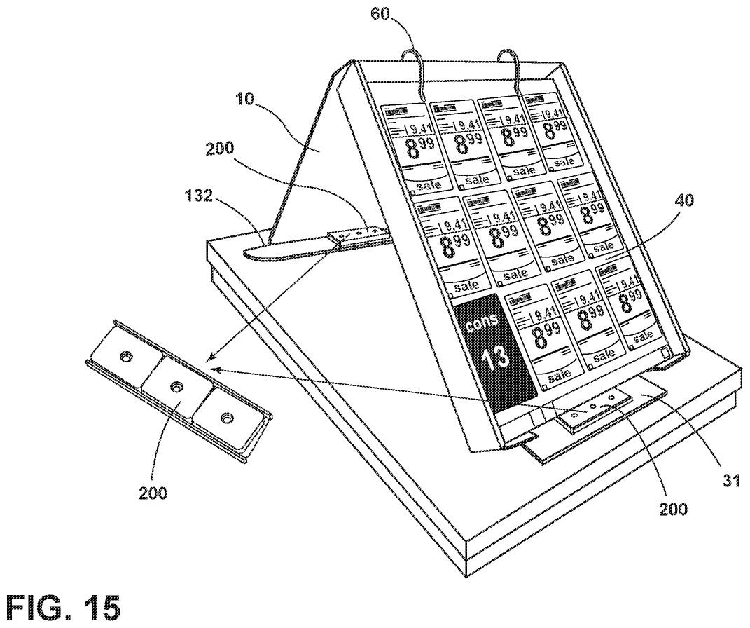

The top surface 10 can also be rotated to position the binder box 4 in an angled manner as shown in FIGS. 1, 15, and 20. In such an arrangement, the fifth binder opening 22 will not overlap the first binder opening 16 and the binder 60 will not be inserted through the fifth binder opening 22. The binder 60 may or may not be inserted through the fourth binder opening 20 in this arrangement. As illustrated in FIG. 15, the binder box assembly 2 may be held in an angled position on a magnetic surface through the use of magnets 200 that cover flaps 31 and 132 of binder box 4.

As illustrated in FIG. 14, the binder box 4 can be made from a single piece of material. The material can be any material that can be punched and perforated. For example, paperboard, cardboard, other cellulose material, polymeric materials, and coated materials can be used. The material can also include multiple layers of material and/or include recycled and/or post-consumer material. Moreover, the material can be biodegradable. The material can also include a generally flat surface and/or a textured surface. In the illustrated examples, the binder box 4 is made from a cardboard material that can be a single or multiple walled corrugated cardboard. The binder box 4 can be made by stamping, cutting, punching, molding or otherwise forming the material from one or more pieces of the same or different materials.

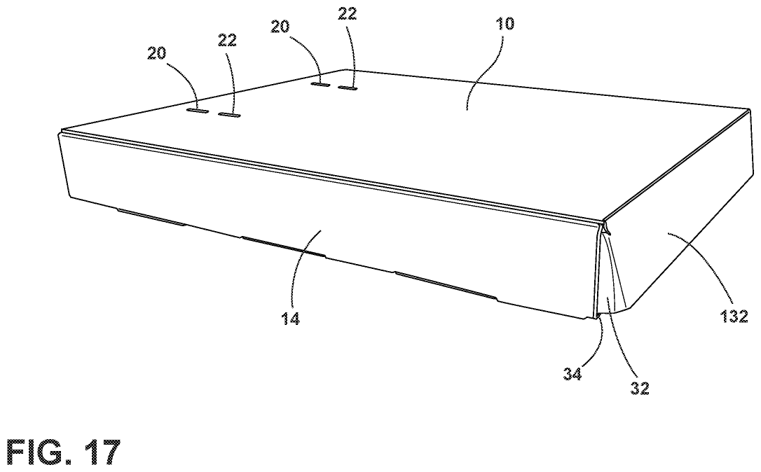

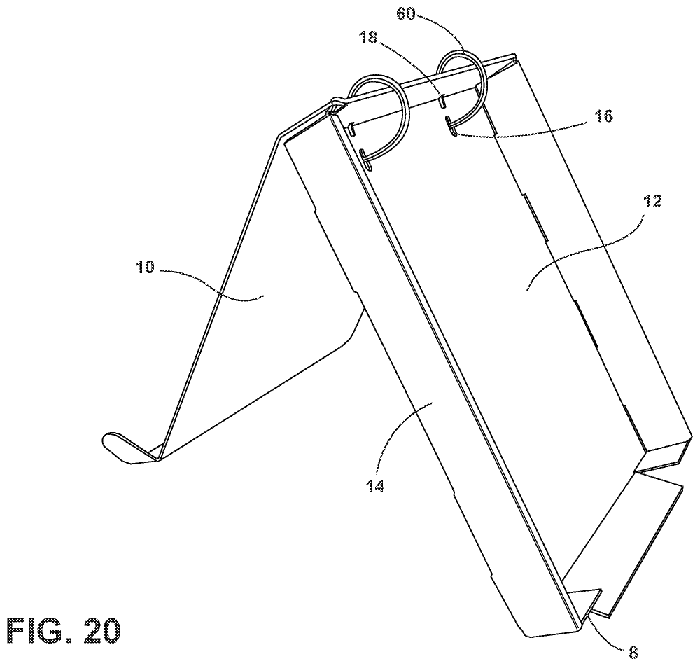

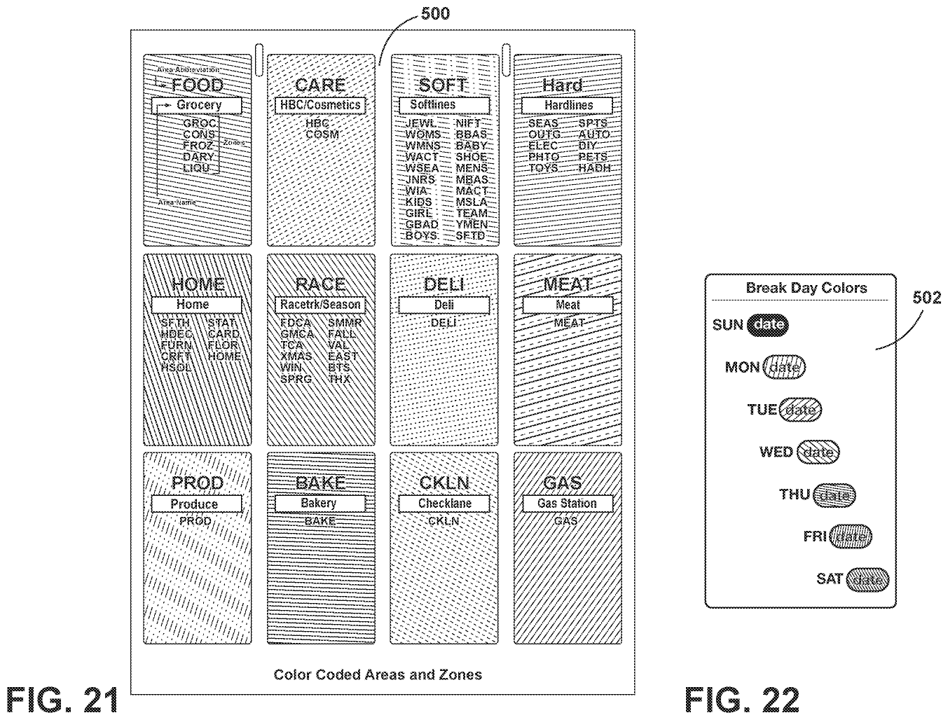

The binder box 4 illustrated in FIG. 14 is made by having tabs 13 on sidewalls 14 folded into openings 15 in the bottom surface 12. When this is done, a pocket 34 (FIG. 17) is formed on the front end of each sidewall 14. The front wall 8 has tabs 11 that can be received in the pockets 34 of the sidewalls 14. The front wall 8 also has perforations 30 that permit a flap 31 to be opened in the front wall as the flap 31 is bent towards the bottom surface 12 as sown in FIGS. 18 and 20. The flap 31 can be entirely removed if torn along the perforated section 35 in the transition 28 between the front wall 8 and the bottom surface 12. The back wall 6 can include tabs 9 that are received in a rearward pocket in sidewalls 14. The top surface 10 include a flap 132 and tabs 32. When the binder box 4 is in a closed position (FIG. 17), the tabs 32 on the top surface 10 will also be received in pockets 34 in the sidewalls 14. This permits the binder box 4 to be shipped or delivered with the sheets 40 of shelf tags 44 enclosed within the binder box 4. Once at the store, the binder box 4 can be opened, the binders 60 installed, and the shelf tags 44 removed from the sheets 40 and installed on shelves. The binder box 4 illustrated in FIG. 14 has a flat dimension of approximately 16.1726 inches wide by 29.2751 inches tall, with the binder openings 16, 18, 20, 22 being approximately 0.16 inches by 0.6 inches-0.7 inches. The second binder openings 18 and the fifth binder openings 22 may be slightly smaller than the first binder openings 16 and the fourth binder openings 20. For example, the second binder openings 18 and the fifth binder openings 22 may have a length of 0.6 inches while the first binder openings 16 and the fourth binder openings 20 have a length of 0.675 inches.

The sheets 40 can include a plurality of shelf tags 44 that are adhered to each sheet 40.

The sheets 40 also have third binder openings 42 that will align over the first binder openings 16 in the bottom surface 12 of the binder box 4 when the sheets 40 are installed in the binder box 4. In the illustrated embodiment the sheets 40 have a pair of third binder openings 42 that are located at the upper portion of the sheet 40 and are positioned in between shelf tags 44. The third binder openings 42 are also generally offset by the same approximate distance from the vertical centerline of the sheet 40. For example, in the illustrated embodiment, each sheet 40 has three rows of four shelf tags. The third binder openings 42 are positioned between the upper ends of the first and second tags 44, and the upper ends of the third and fourth tags 44 in the first row as shown in FIG. 15. When the sheets 40 are placed in the binder box 4, there should be a gap A between the top of the sheets 40 and the transition 26 between the back wall 6 and the bottom surface 12 of the binder box 4. In the illustrated embodiment, the gap A can be approximately 0.375 inches.

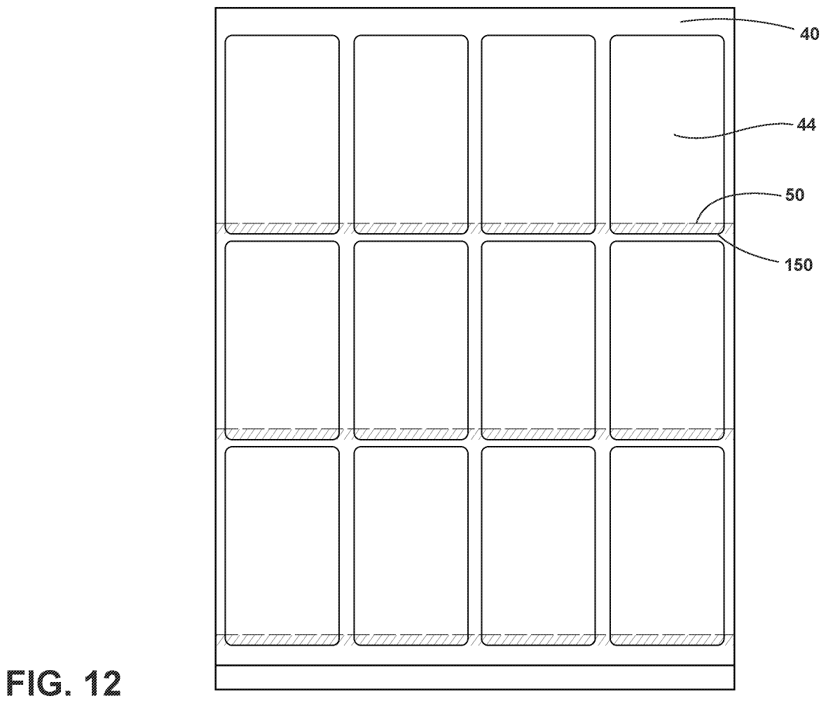

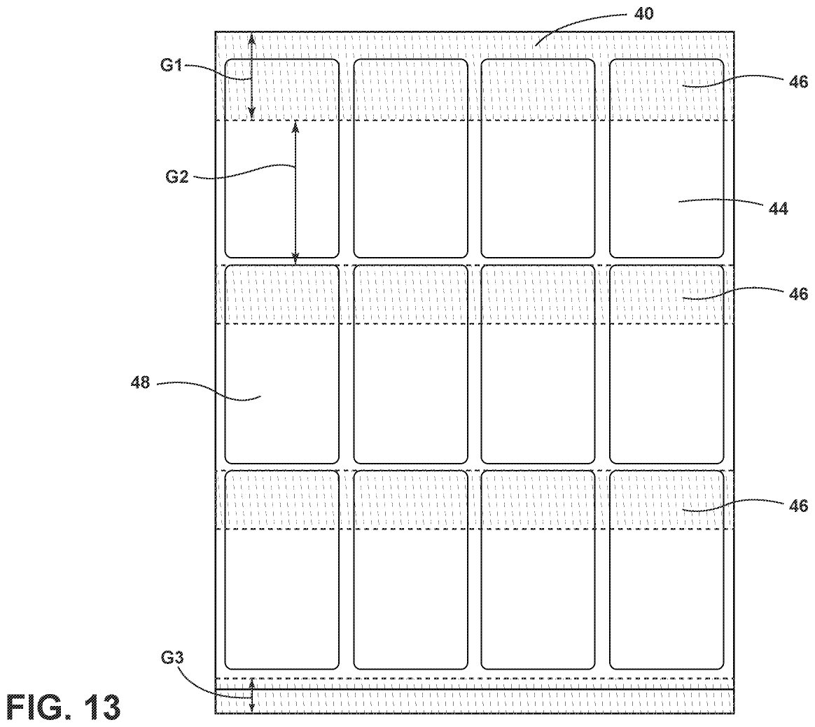

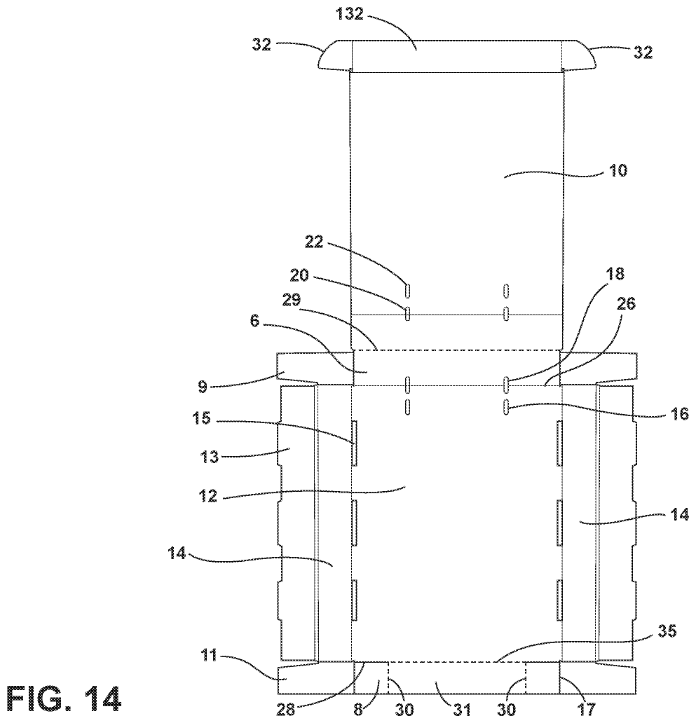

The shelf tags 44 can be attached to the sheets 40 in a variety of ways. For example, the shelf tags 44 can include adhesive on all of the shelf tags 44 (FIG. 12) or a part of the shelf tags 44 (FIG. 13). In addition, the sheets 40 can include perforations 50 that permit the sheet 40 to be bent to lift a portion 150 of the shelf tags 44 away from the sheet 40. Instead of perforations 50, the sheets 40 could include a pre-bent section. When a portion of the shelf tag 44 dos not include active adhesive, the height G1 of the first glue section (FIG. 13) can be approximately 1 inch-2 inches and more preferably approximately 1.472 inches at the top of the 9 inches wide by 12 inches tall sheet 40. Each shelf tag 44 is approximately 2 inches by 2.5 inches. The distance G2 between the first glue section G1 and the second glue section is between 1.5 inches and 2 inches and more preferably approximately 1.72 inches. The remaining glue strip heights for the other three rows is approximately 1 inches to 1.25 inches and more preferably approximately 1.03 inches. The bottom glue strip G3 has a height of between 0.05 inches and 1 inches and more preferably approximately 0.625 inches. The portions of the shelf tags 44 that do not have active adhesive may have deadened sections 48 of adhesive or no adhesive whatsoever. While the illustrated example is a 9×12 inch sheet 40 with 12 shelf tags 44, any number of shelf tags 44 can be included on a 9×12 inch sheet 40, and/or the sheet 40 can be a different size. If the number of shelf tags 44 and/or the size of the sheet 40 is altered, the measurements of spacing and glue sections may be altered as well. In addition, the shelf tags 44 can be attached to and/or released from the sheet 40 in any other manner.

The perforations 50 can be positioned to release the bottom surface of the shelf tag 44 (as shown in FIG. 12). However, the perforations 50 can also be positioned to release a side surface or the top surface of the shelf tag 44. The use of perforations 50 on the sheet 40 can be with shelf tag 44 on the sheets 40, signs 302 or strips. The perforations 50 can also be partially or entirely torn away to access the tag 44, sign 302 or strips.

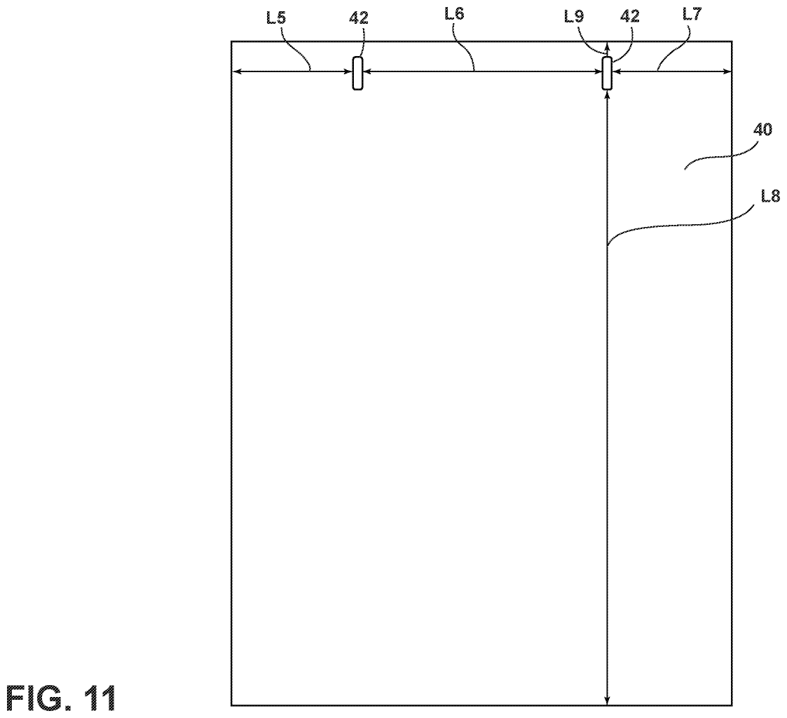

The 9×12 inch sheet 40 can have third binder openings 42 that are approximately 0.016 inches by 0.6 inches with a 0.04 inches corner radius. An exemplary spacing of the third binder openings 42 on sheets 40 is illustrated in FIG. 11 with L5 and L7 being approximately 2.17 inches, L6 being approximately 4.34 inches, L9 being approximately 0.278 inches, and L8 being approximately 11.122 inches. Again, this is simply an exemplary embodiment of the sheet 40 that can vary based upon size of the sheet and the number and/or spacing of the third binder openings 42. For example, the sheets 40 could be smaller and/or not include openings 42 such that they can be printed on any printing device.

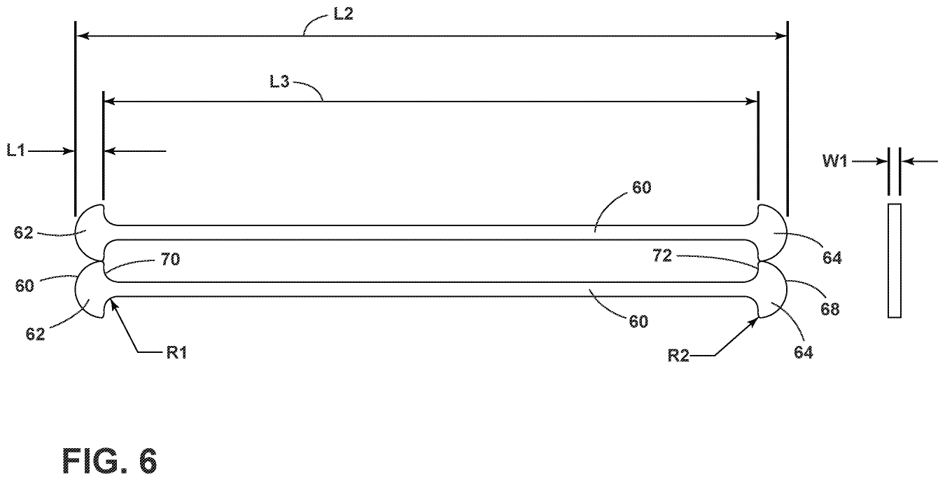

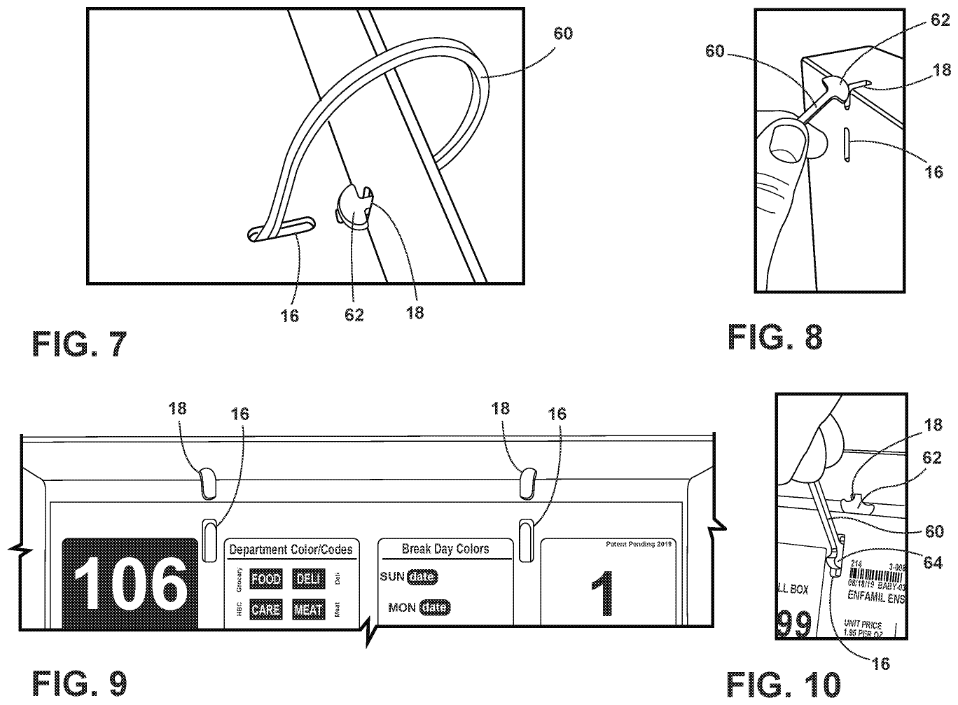

The binder 60 has a first end 62 with a rounded end 66 and a second end 64 with a rounded end 68. The first end 62 included shoulders 70 and the second end 64 includes shoulders 72 that will engage surfaces on the binder box 4. The rounded ends 66, 68 permit the binder 60 to be easily inserted into the associated binder openings (16, 18, 20, 22, and/or 42) before being rotated to have the shoulders (70, 72) engage surfaces on the binder box 4. As illustrated in FIG. 6, the binder 60 can have an overall length L2 of approximately 6.25 inches and the spacing L3 between the ends (62, 64) can be approximately 5.75 inches. Each end (62, 64) can have a length L1 of approximately 0.25 inches with a radius R1 of approximately 0.118 inches and a radius R2 of approximately 0.03 inches. The width W1 of the binder 60 can be approximately 0.10 inches and the width W2 of each end (62, 64) being greater than W1 to create shoulders 70, 72. As shown in FIG. 6, the binders 60 can come as a set that can be separated by the end user. The binder 60 can be made of any flexible material and have any cross-sectional shape to provide a mechanical and/or physical coupling with the binder box 4. In the illustrated example, the binder 60 is made of a polymeric material, and, more specifically, of a low-density polyethylene.

One end (62, 64) of the binder 60 is inserted from the bottom side of the binder box 4 into the second binder opening 18 that may or may not be aligned with the fourth binder opening 20 depending upon the position of the top surface 10. The binder 60 is then turned a quarter turn to lock the end (62, 64) of the binder 60 in place. The other end (62, 64) of the binder 60 is wrapped around the back wall 6 of the binder box 4 and inserted through the third binder opening 42 in the sheets 40 and through the first binder opening 16 in the binder box 4. That end (62, 64) is rotated a quarter turn to lock it into place. The shoulders 70, 72 on each end of the binder 60 keep the binder 60 engaged to surfaces on the binder box 4. The binder 60 may be inserted into the third binder opening 42 in the sheets 40 and the first binder opening 16 before the binder 60 is inserted into the second binder opening 18.

In this arrangement, the sheets 40 can be flipped once the shelf tags 44 have been used.

This is especially important when the tags 44 have been printed in planogram order, thereby permitting easy and quick installation of the shelf tags 44 as the person moves down aisles or within the store.

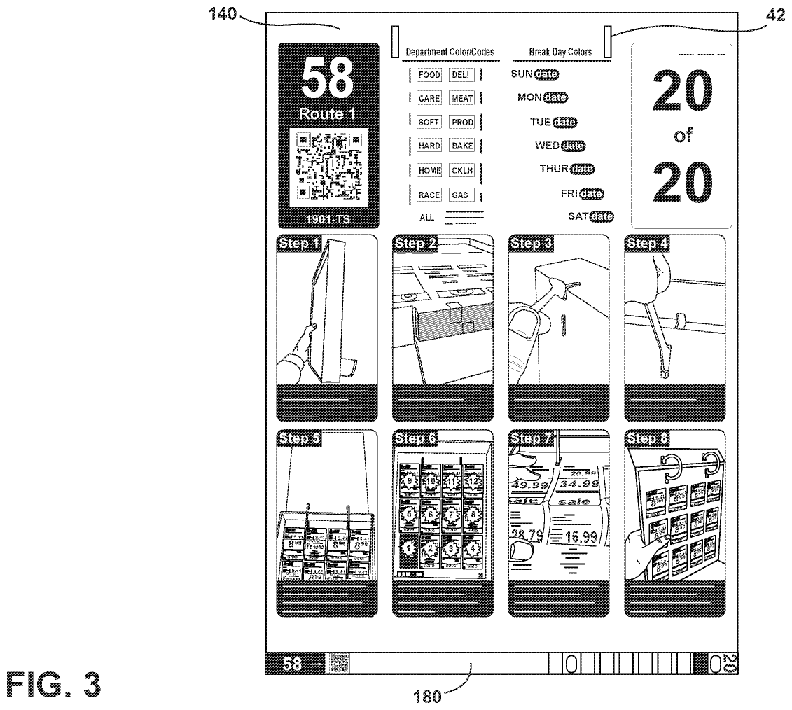

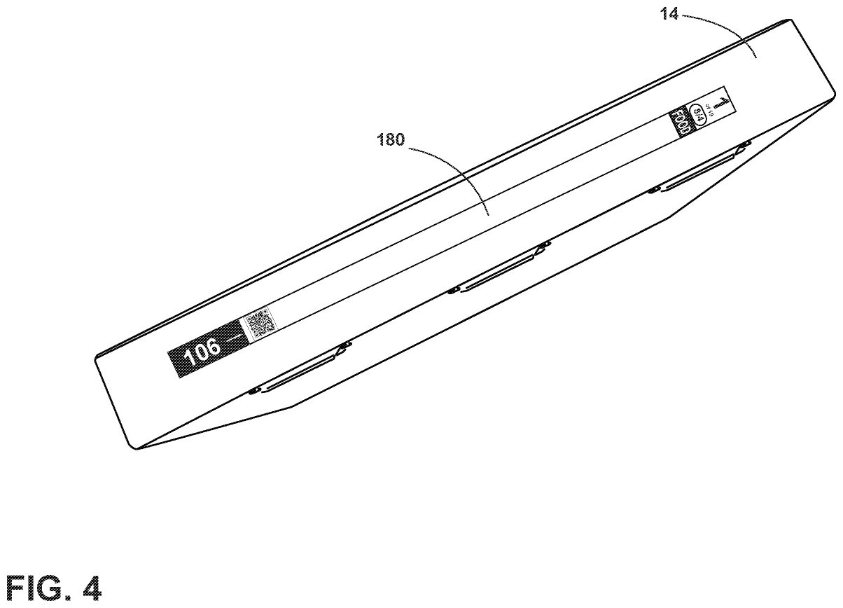

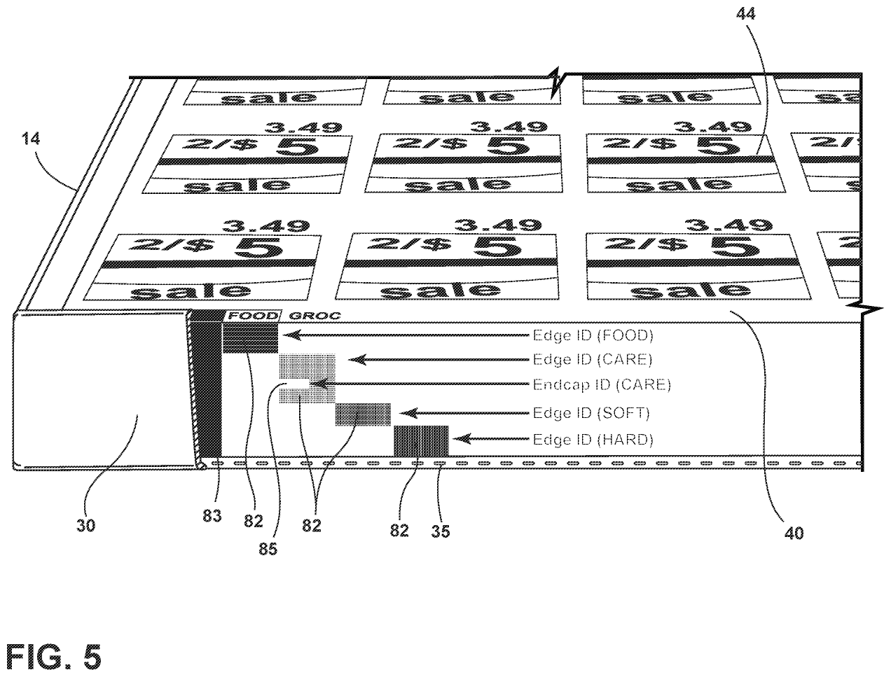

The flap 31 on binder box 4 that can be opened and/or removed to access the lower ends of the sheets 40. The sheets 40 can have an edge identification 82 (FIG. 5) that permits color coding and/or other organization of the sheets 40 by product, section, or other distinguishing feature for purposes of the store. The binder box 4 can have a label 180 that is on a surface of the binder box 4 to identify the binder box 4 as far as date, store, or other information. As illustrated in FIGS. 2 and 3 one or more of the sheets 40 can contain instructions for assembly and/or use of the binder box assembly 2 and/or can contain labels for attaching to the binder box 4. The shelf tags 44 do not need to be uniform size and can contain various information such as price, stocking status, and any other information.

Spacers can be placed within the compilation of sheets 40. The spacers can be used to separate different groupings of sheets 40. The spacers are color coded to provide a distinct visual break so that the end-user knows that there is a transition within the compilation of sheets 40 to a new grouping of sheets for a different purpose (such as date, section of store, end cap, tag, sign, strip, etc.).

In addition, to the extent a sheet 40 has two or more zones of a store on the sheet 40, the edge identification 82 can show multiple zones on the sheet 40, and a tile on the sheet 40 can show where the new zone of tags 44 starts.

A tile sheet 140 can be included at the top of the compilation of sheets 40. The tile sheet 140 can include custom information for the store, including announcements, color coding information, store number, page number, department number, edge identification, end cap information, aisle information, packaging information, and instructions for placing the shelf tags 44. The tile label 180 can be included on the tile sheet 140 for removal to be placed on the binder box 4. The tile label 180 includes information such as store number, box number, planogram/aisle information, and/or quick response (QR) code(s). A page label 80 can also be on the tile sheet 140 and/or another sheet 40 for indicating what types of tags 44 are on the sheet 40, the date information, page numbering, etc.

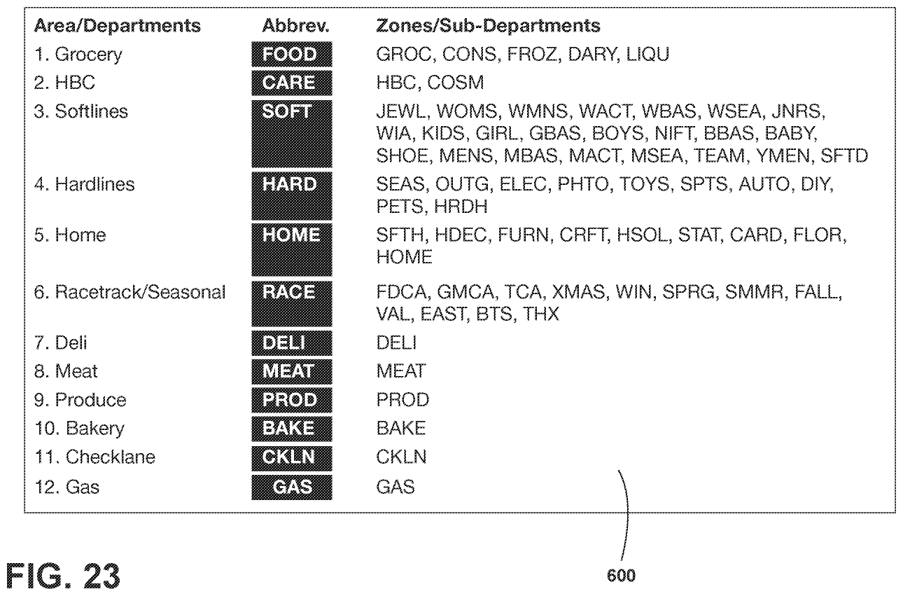

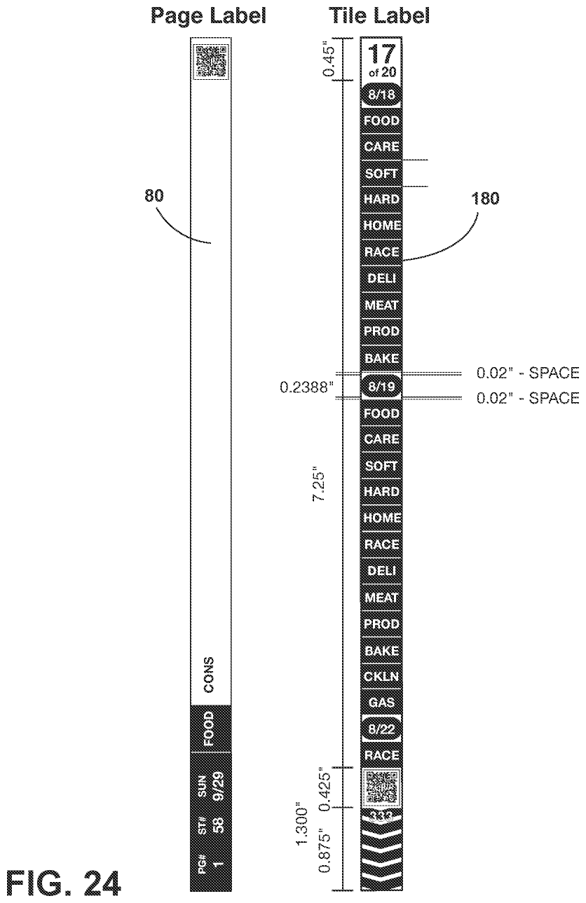

Color identification can be used to show both different areas of a store and date information. Color identification can be used to show where and when a tag 44 is to be placed. Thus, a color tile sheet 500 can be included within the compilation of sheets 40 to show the associated colors for various sections of the store that will be used on the edge identification 82. A break day identification sheet 502 can also show the colors that will be used with the break date identification 83. A more detailed chart 600 can be included to explain the color codes and abbreviations (see FIG. 23). The edge identification 82 colors are printed on an edge surface of a sheet 40 to show the area of the store with the different colors being offset.

Sheets with similar edge identification 82 can be grouped into one or more groupings.

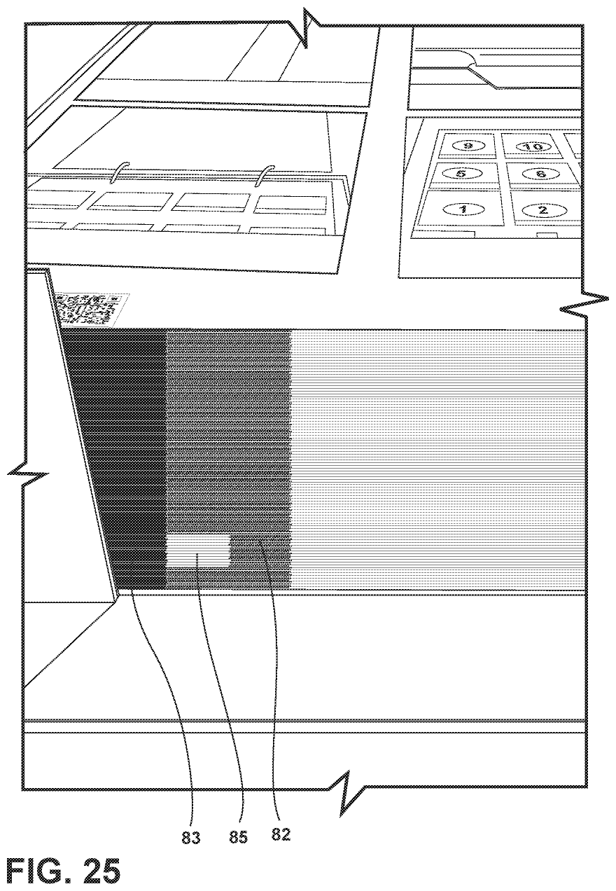

Groups of different colored edge identification 82 are offset on an edge surface of the sheets 40 (FIG. 5) in order to visually distinguish the groupings. A more narrow section of color illustrated as an absence of color 85 within the edge identification 82 can be used to show that a sheet 40 contains an end cap tag 44 (see FIG. 25).

While the edge identification 82 and date identification 83 are shown as printed on the same edge surface of the sheets 40, they could be printed on different edge surfaces. In addition, while the edge identification 82 and date identification 83 are shown on the bottom edge surface, one or more could be on a side or top edge surface.

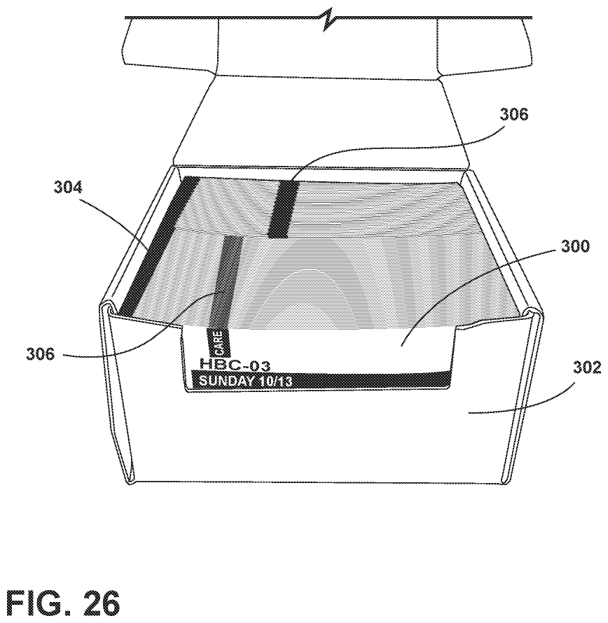

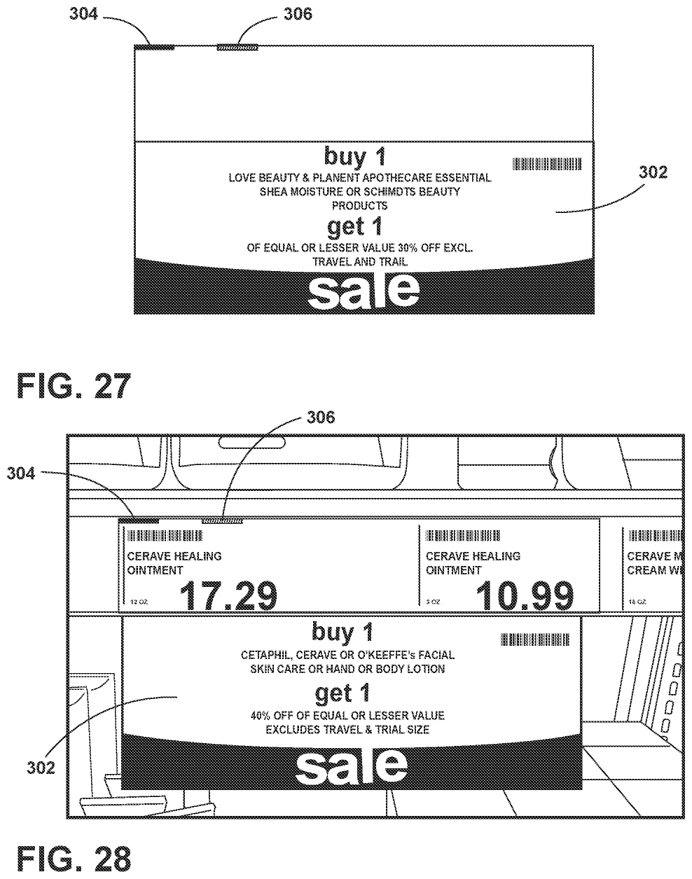

The edge identification coloring can also be used on signs 300, planogram strips, a smaller version of the sheets 40 or shelf strips. Examples of the edge identification coloring on signs/strips is shown in FIGS. 26-28. The break date 304 and edge identification 306 can be used to show the date and store area information for installation of the signs 300, smaller tags and/or strips.

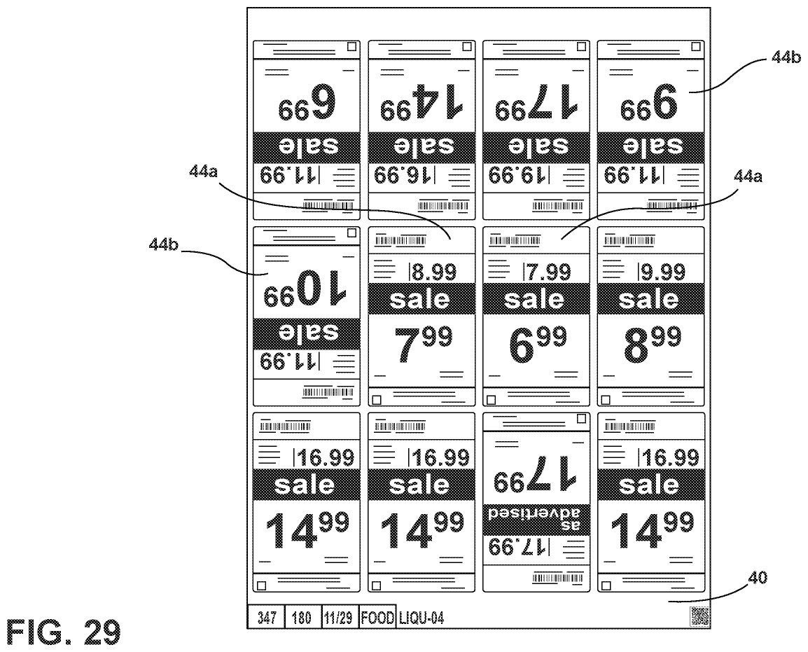

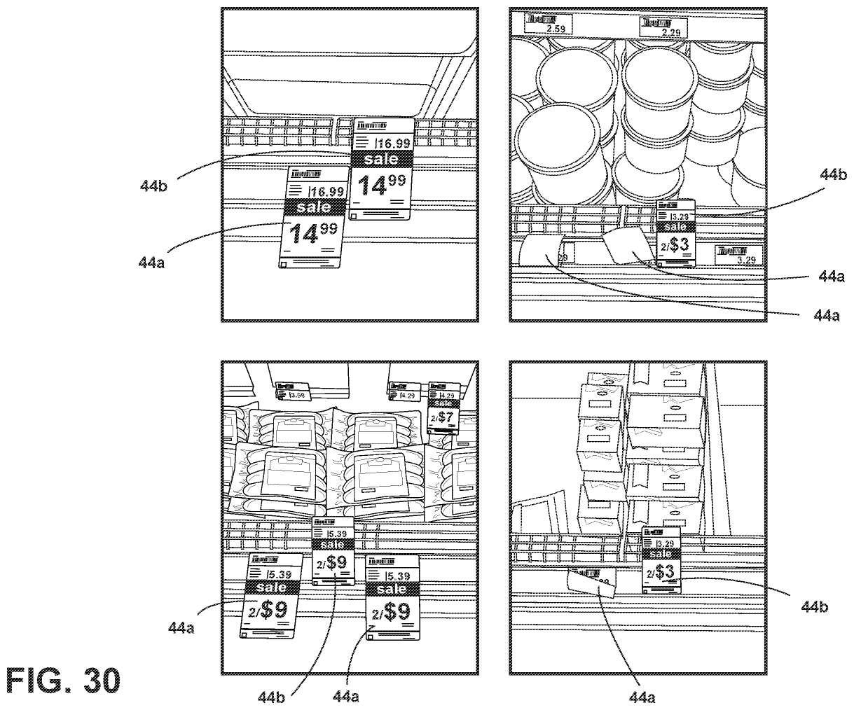

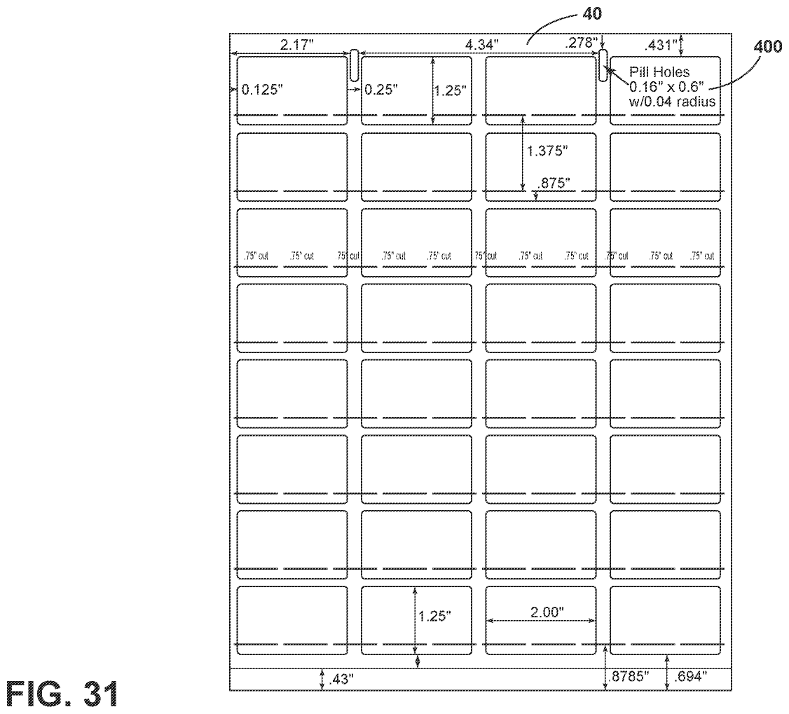

FIG. 29 illustrates a sheet 40 of shelf tags 44 which include shelf tags 44 that have the information on the shelf tag 44 rotated 180°. Shelf tags 44 or signs that hang down in front of customers and cart traffic can be damaged easily. Thus, it can be advantageous to have the tag extend upward (as shown in FIG. 30) so that it is out of the way of customer and cart traffic, reducing damage to the tag/sign. FIG. 30 illustrates downward hanging shelf tags 44a that have been damaged and upward extending shelf tags 44b that have not been damaged. In order to produce tags designed to extend upward from a store shelf/surface, the image of the tag is rotated 180° before being printed on a sheet where the active adhesive 46 is located at the top of the tag, such as the sheets shown in FIG. 13.

As illustrated in FIG. 29, some of the shelf tags 44 can be printed in a normal orientation to be hung downward, while some can be printed so that the active adhesive 46 will be at the bottom of the shelf tag 44 so it can extend upward. The printing of tags in this manner allows the shelf tags 44 to still be printed for hanging downward or extending upward depending upon the height of the shelf the shelf tag 44 is to go on. While the illustrated embodiments of FIGS. 29 and 30 illustrate shelf tags 44 where the active adhesive 46 is located only on the top portion of the shelf tag 44 when on the sheet 40, the active adhesive 46 could be positioned on the bottom of the shelf tags 44 with the top portion of the shelf tag 44 having no adhesive or a deadened adhesive. Similarly, the active adhesive 46 could be positioned on a side of the shelf tag 44 and still have information printed in a rotated manner on the shelf tag 44. While the illustrated embodiments show shelf tags 44, the same rotated printing can be used for signs or other printed materials that have a portion of adhesive for sticking to a shelf or other surface within a store. Moreover, the sheets 40 may include perforations to permit the bending of the sheet 40 to expose a surface of the shelf tags for removal from the sheet.

The adhesive applied to the shelf tag 44, sign, label, etc., could be applied in a pattern, such as dots, strips, lines, etc. Similarly, the deadening of any adhesive could be done to create a pattern of active adhesive by deadening sections of the adhesive.

The sheet 40 can include unit price labels 400 that are inserted into the plastic shelf channel and do not require active adhesive. The unit price labels 400 can include a deadened adhesive on the back of the unit price labels 400. The deadened adhesive can be a full kill of the adhesive such that the unit price label 400 adheres to the sheet 40 during printing, but when the end-user removes the unit price label 400, the entirety of the unit price label 400 has a dry backside. While the unit price labels 400 have been illustrated as being sized to replace typical perforated paper unit price labels in a plastic shelf channel, the unit price label 400 could be larger or could be a sign or any other printed material that is desired to not have an active adhesive back. Moreover, the sheets 40 of unit price labels 400 can include perforations to assist in removing the unit price label 400 from the sheet 40, as described above.

The sheets 40 can be sized, such as 8.5×11 inches, to be printed on a printer at the store. Thus, sheets 40 can have various sized stock labels/tags/signs with various adhesive and/or deadened adhesive sections. The edge identification 82, tile sheets 500, etc. can be used with the unit price label 400.

Some of the tags/signs can come with deadened adhesive and/or no adhesive backing, permitting the tags/signs to be placed into holders on the shelf. This permits the easy removal of the tags/signs from such holders. The holders are typically polymeric holders that are coupled to a channel or other part of a shelf, and the lack of adhesiveness on the backside of the tags/signs makes them easy to slide in and out of the holder.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention is claimed as follows:

1. A sheet of shelf tags, comprising:
a plurality of shelf tags coupled to the sheet with a section of active adhesive located near the upper end of said shelf tags with the remainder of the shelf tag lacking active adhesive;
information printed on said plurality of shelf tags such that shelf tags that will hang downward on a shelf will have information printed on the shelf tag in a first orientation, and shelf tags that will extend upward on a shelf will have information printed on the shelf tag in a second orientation which is 180° different than said first orientation; and
wherein said sheet includes shelf tags printed in said first orientation and shelf tags printed in said second orientation.

2. The sheet of shelf tags of claim 1, wherein said shelf tags are printed in planogram order.

3. The sheet of shelf tags of claim 1, wherein the height of said active adhesive on said shelf tags is less than 50 percent of the height of the shelf tag.

4. The sheet of shelf tags of claim 1, wherein the sheet of shelf tags includes perforations in the sheet that permit the bending of the sheet to expose a surface of the shelf tags for removal from the sheet.

5. The sheet of shelf tags of claim 1, including a first narrow section of color printed on a portion of an edge surface of the sheet for indicating in what area of a store the shelf tags are to be placed.

6. The sheet of shelf tags of claim 5, including a second section of color printed on a portion of an edge surface to indicate the date on which one or more of the shelf tags is to be placed on the shelf within the store.

7. The sheet of shelf tags of claim 6, wherein the first section and second section of colors are printed on the same edge surface of the sheet of shelf tags.

8. A sheet of unit price labels for installation in a plastic shelf channel, comprising:
a plurality of unit price labels having deadened adhesive, said unit price labels sized to fit into a plastic shelf channel;
information printed on a plurality of the unit price labels; and
perforations on said sheet that permit the bending of the sheet to expose a surface of the unit price labels for removal from the sheet.

9. The sheet of unit price labels of claim 8, wherein the unit price labels are printed in planogram order.

10. The sheet of unit price labels of claim 8, including a first narrow section of color printed on a portion of an edge surface of the sheet for indicating in what area of the store the unit price labels are to be placed.

11. The sheet of unit price labels of claim 10, including a second section of color printed on a portion of an edge surface to indicate the date on which one or more of the unit price labels is to be placed in the plastic shelf channel.

12. The sheet of unit price labels of claim 8, wherein the sheet is 8.5×11 inches.

13. The sheet of unit price labels of claim 8, wherein the deadened adhesive is a full kill adhesive resulting in a dry backside on the unit price labels.

14. A plurality of sheets of shelf tags, comprising:
a plurality of shelf tags coupled to a plurality of sheets with a section of active adhesive located near the one end of said shelf tags with the remainder of the shelf tag lacking active adhesive;
information printed on said plurality of shelf tags such that shelf tags that will hang downward on a shelf will have information printed on the shelf tag in a first orientation, and shelf tags that will extend upward on a shelf will have information printed on the shelf tag in a second orientation which is 180° different than said first orientation; and
wherein said sheets include shelf tags printed in said first orientation and shelf tags printed in said second orientation.

15. The plurality of sheets of shelf tags of claim 14, wherein said plurality of sheets of shelf tags are printed in planogram order.

16. The plurality of sheets of shelf tags of claim 14, wherein the height of said active adhesive on said one end is less than 50 percent of the height of the shelf tag.

17. The plurality of sheets of shelf tags of claim 14, wherein the plurality of sheets of shelf tags includes perforations in the sheets that permit the bending of the sheets to expose a surface of the shelf tags for removal from the sheets.

18. The plurality of sheets of shelf tags of claim 14, including a first narrow section of color printed on a portion of an edge surface of the sheets for indicating in what area of a store the shelf tags are to be placed.

19. The plurality of sheets of shelf tags of claim 18, including a second section of color printed on a portion of an edge surface to indicate the date on which one or more of the shelf tags is to be placed on the shelf within the store.

20. The plurality of sheets of shelf tags of claim 19, wherein the first section and second section of colors are printed on the same edge surface of the sheets of shelf tags.
